(19) United States
(12) Patent Application Publication
(10) Pub. No.: US 2026/0001603 A1
(43) Pub. Date: Jan. 1, 2026

(54) Stabilizing Apparatus For A Motorcycle

(71) Applicant: Steven Ridge, Farmersburg, IN (US)

(72) Inventor: Steven Ridge, Farmersburg, IN (US)

(21) Appl. No.: 18/756,615

(22) Filed: Jun. 27, 2024

(51) Int. Cl. B62H 7/00

(52) U.S. Cl. CPC B62H 7/00

(57) ABSTRACT

A stabilizing apparatus for stabilizing a motorcycle or like vehicle during operation includes a first mounting bracket and a second mounting bracket. The first and second mounting brackets are configured to fixedly mount to a rear wheel frame of the motorcycle on opposite sides of the motorcycle from each other, and each of the first and second mounting brackets comprises a rigid material. A first wheel first wheel is rotatably coupled to the first mounting bracket, and a second wheel is rotatably coupled to the second mounting bracket. The first and second wheels are configured to be translationally fixed with respect to a rear wheel of the motorcycle when the first and second mounting brackets are mounted to the rear wheel frame.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to stabilizing apparatuses and more particularly pertains to a new stabilizing apparatus for stabilizing a motorcycle or like vehicle during operation.

### (2) Description of Related Art Including Information Disclosed Under 37 CFR 1.97 and 1.98

The prior art discloses various stabilizing apparatuses for stabilizing a motorcycle during use. However, stabilizing apparatuses of the prior art include resiliently bendable or otherwise deformable members which act similar to a suspension to absorb impacts from driving over uneven surfaces or the like. Such features introduce complexity and decrease durability of the apparatus, leading to apparatuses which are easy to break in extreme environments such as off road. The prior art fails to describe such an apparatus which fixedly mounts to a rear wheel frame of the motorcycle such that the rear wheel of the motorcycle and the apparatus share a suspension system.

### BRIEF SUMMARY OF THE INVENTION

An embodiment of the disclosure meets the needs presented above by generally comprising a first mounting bracket and a second mounting bracket. The first and second mounting brackets are configured to fixedly mount to a rear wheel frame of the motorcycle on opposite sides of the motorcycle from each other, and each of the first and second mounting brackets comprises a rigid material. A first wheel first wheel is rotatably coupled to the first mounting bracket, and a second wheel is rotatably coupled to the second mounting bracket. The first and second wheels are configured to be translationally fixed with respect to a rear wheel of the motorcycle when the first and second mounting brackets are mounted to the rear wheel frame.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a disassembled perspective view of a stabilizing apparatus according to an embodiment of the disclosure.

FIG. 2 is a front view of a mounting bracket, a shaft, and a wheel of an embodiment of the disclosure.

FIG. 3 is a rear view of a mounting bracket, a shaft, and a wheel of an embodiment of the disclosure.

FIG. 4 is a rear view of a mounting bracket, a shaft, and a wheel of an embodiment of the disclosure.

FIG. 5 is an in-use view of an embodiment of the disclosure.

### DETAILED DESCRIPTION OF THE INVENTION

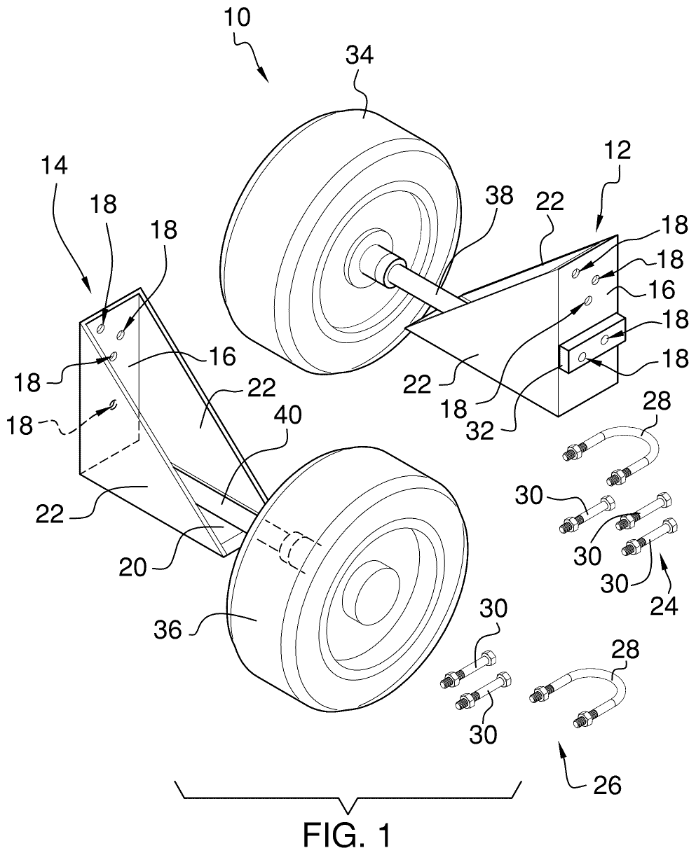

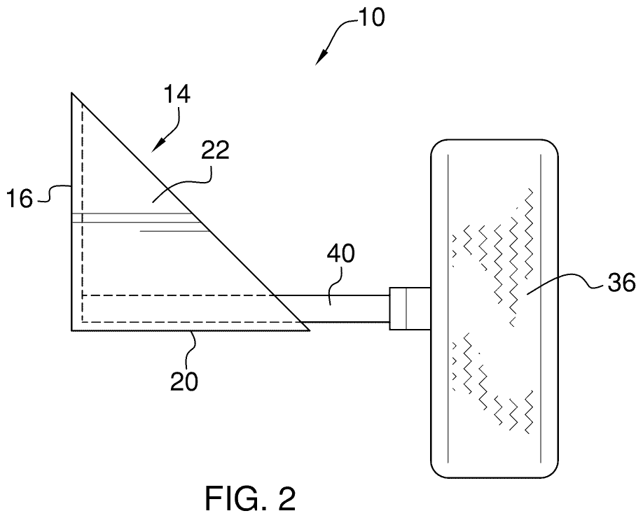

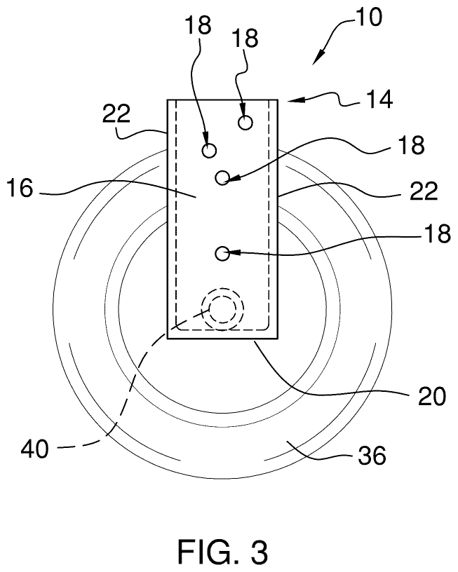

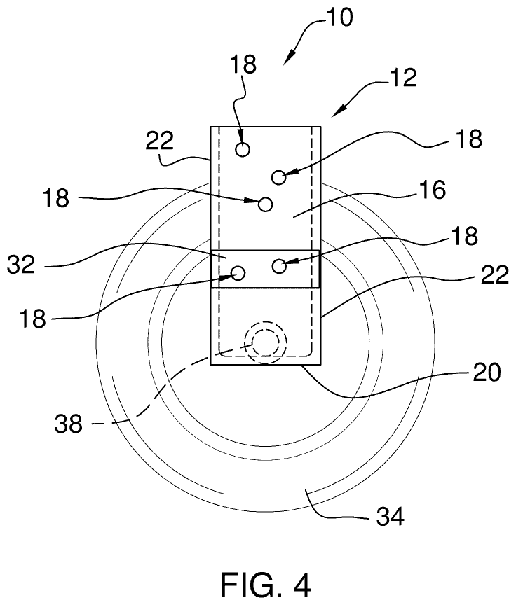

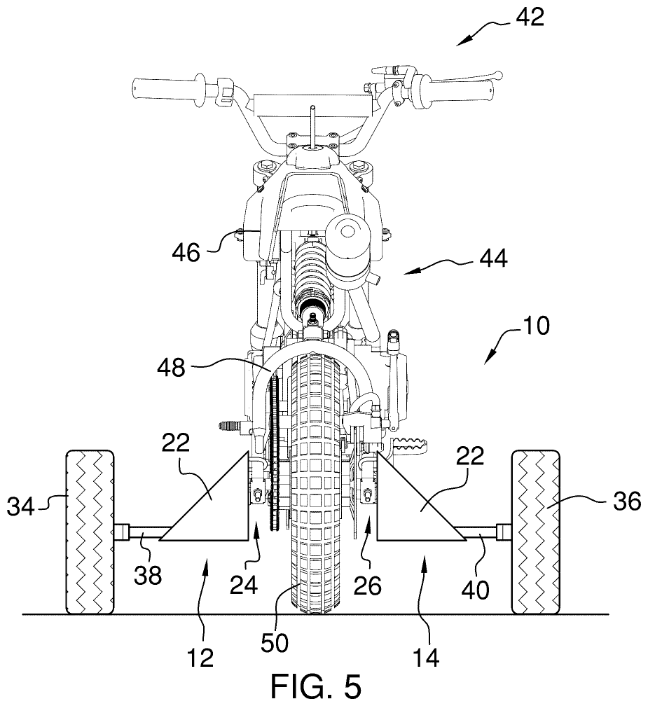

With reference now to the drawings, and in particular to FIGS. 1 through 5 thereof, a new stabilizing apparatus embodying the principles and concepts of an embodiment of the disclosure and generally designated by the reference numeral 10 will be described.

As best illustrated in FIGS. 1 through 5, the stabilizing apparatus 10 generally comprises assemblies for attaching to a motorcycle 42 to stabilize the motorcycle 42 from tipping over either to the left or the right. Such assemblies may be used, for example, to train young or inexperienced users of a motorcycle to use the motorcycle without being required to maintain balance against the motorcycle tipping over.

It is understood that the term “motorcycle” as used in this disclosure refers to a powered vehicle in which the wheels supporting the vehicle are arranged inline with a front-to-back direction of the vehicle. Typically, such vehicles have two such wheels, a front wheel and a rear wheel 50, wherein the front wheel is steerable with respect to a body 44 of the motorcycle and the rear wheel 50 is fixed from rotating about a vertical axis during normal use. Other arrangements are possible, including ones which use of a different number of wheels and those with varying combinations of steerable and fixed wheels. For example, the rear wheel 50 may be steerable and the front wheel may be fixed. It is further understood that the term “motorcycle” as used in this disclosure includes mopeds, scooters, powered bicycles, and the like.

The stabilizing apparatus 10 is generally directed to attach to a rear wheel frame 48 of the motorcycle 42 which rotatably supports a rear wheel 50 of the motorcycle 42 and is movable relative to a main portion 46 of the motorcycle's 42 body 44. A suspension system may resist intermittent forces such as those experienced by driving the motorcycle 42 over uneven terrain. The stabilizing apparatus 10 comprises a first mounting bracket 12 and a second mounting bracket 14, each of which fixedly mounts to the rear wheel frame 48 of the motorcycle 42 on opposite sides of the motorcycle 42 from each other. Each of the first and second mounting brackets 12, 14 comprises a rigid material such as a metal of sufficient strength to resist deformations during use.

Each of the first and second mounting brackets 12, 14 comprises a connection plate 16, an extension plate 20, and a pair of gussets 22. The connection plate 16 couples to the rear wheel frame 48 via fasteners 24, 26 which extend through mounting holes 18 defined in the connection plate 16. A first set of fasteners 24 couples the connection plate 16 of the first mounting bracket 12 to the rear wheel frame 48, and a second set of fasteners 26 couples the connection plate 16 of the second mounting bracket 14 to the rear wheel frame 48. The extension plate 20 of each bracket is coupled to and extends away from the connection plate 16, thereby forming an L-shape with the connection plate 16. The pair of gussets 22 is coupled to the connection plate 16 and the extension plate 20 to strengthen the respective mounting bracket 12, 14 against bending and shearing forces. The gussets 22 are spaced from each other across the connection plate 16 and the extension plate 20.

Each set of fasteners 24, 26 engages the rear wheel frame 48 to attach the respective mounting bracket 12, 14 to the rear wheel frame 48. Each set of fasteners 24, 26 includes a nut-and-U-bolt assembly 28 which may be used to extend around an elongated portion of the rear wheel frame 48 and clamp the respective mounting bracket 12, 14 to the rear wheel frame 48. Each set of fasteners 24, 26 further includes a plurality of nut-and-bolt assemblies 30 which may extend through holes in the rear wheel frame 48 to clamp the respective mounting bracket 12, 14 to the rear wheel frame 48. In other embodiments, various other fasteners 24, 26 may be used, including screws, weldments, force fits, or the like.

A spacer 32 is depicted in various Figures which is used to facilitate accurate alignment of the first mounting bracket 12 with the rear wheel frame 48. However, it is noted that such structures will be dependent on the shape of the motorcycle 42 used with any of various embodiments of the spacing assembly 10 described here. Other spacers or varied shapes of connection plates 16 may be used as needed for accurate alignment.

A first wheel 34 is rotatably coupled to the first mounting bracket 12 via a first shaft 38 coupled to the extension plate 20 and positioned between the pair of gussets 22 of the first mounting bracket 12. The second wheel 36 is likewise rotatably coupled to the second mounting bracket 14 via a second shaft 40 coupled to the extension plate 20 and positioned between the pair of gussets 22 of the second mounting bracket 14. So mounted, the first and second wheels 34, 36 are translationally fixed with respect to the rear wheel 50 of the motorcycle 42 when the first and second mounting brackets 12, 14 are mounted to the rear wheel frame 48. Stated another way, the first and second wheels 34, 36 rely on the motorcycle's 42 suspension system rather than any additional suspension between the first or second wheel 34, 36 and the first or second mounting bracket 12, 14 respectively.

In use, the motorcycle 42 is driven with the stabilizing apparatus 10 mounted thereto such that a user of the motorcycle 42 may maintain balance on the motorcycle 42. The wheels 34, 36 of the stabilizing apparatus 10 move in tandem with the rear wheel 50 of the motorcycle 42 as the rear wheel 50 or the wheels 34, 36 impact obstructions causing vibrations or intermittent jerking movements.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A stabilizing apparatus for a motorcycle, the apparatus comprising:
a first mounting bracket and a second mounting bracket, the first and second mounting brackets being configured to fixedly mount to a rear wheel frame of the motorcycle on opposite sides of the motorcycle from each other, each of the first and second mounting brackets comprising a rigid material; and
a first wheel and a second wheel, the first wheel being rotatably coupled to the first mounting bracket, the second wheel being rotatably coupled to the second mounting bracket, the first and second wheels being configured to be translationally fixed with respect to a rear wheel of the motorcycle when the first and second mounting brackets are mounted to the rear wheel frame.

2. The apparatus of claim 1, wherein:
each of the first and second mounting brackets comprises:
a connection plate configured to couple to the rear wheel frame, the connection plate defining a plurality of mounting holes which extend through the connection plate; and
an extension plate coupled to and extending away from the connection plate; and
a first set of fasteners and a second set of fasteners, the first set of fasteners being insertable through the mounting holes of the connection plate of the first mounting bracket, the second set of fasteners being insertable through the mounting holes of the connection plate of the second mounting bracket, the first and second sets of fasteners being configured to couple to the rear wheel frame of the motorcycle.

3. The apparatus of claim 2, wherein the connection plate and the extension plate of each of the first and second mounting brackets forms an L-shape.

4. The apparatus of claim 2, wherein each of the first and second mounting brackets further comprises a gusset coupled to the connection plate and the extension plate.

5. The apparatus of claim 4, wherein the gusset of each of the first and second mounting brackets is one of a pair of gussets coupled to the connection plate and the extension plate, the gussets being spaced from each other across the connection plate and the extension plate.

6. The apparatus of claim 2, wherein each of the first and second sets of fasteners includes a nut-and-U-bolt assembly.

7. The apparatus of claim 2, wherein each of the first and second sets of fasteners includes a nut-and-bolt assembly.

8. A stabilizing apparatus for a motorcycle, the apparatus comprising:
a first mounting bracket and a second mounting bracket, the first and second mounting brackets being configured to fixedly mount to a rear wheel frame of the motorcycle on opposite sides of the motorcycle from each other, each of the first and second mounting brackets comprising a rigid material, each of the first and second mounting brackets comprising:
a connection plate configured to couple to the rear wheel frame, the connection plate defining a plurality of mounting holes which extend through the connection plate;
an extension plate coupled to and extending away from the connection plate, the connection plate and the extension plate forming an L-shape; and
a pair of gussets coupled to the connection plate and the extension plate, the gussets being spaced from each other across the connection plate and the extension plate;
a first set of fasteners and a second set of fasteners, the first set of fasteners being insertable through the mounting holes of the connection plate of the first mounting bracket, the second set of fasteners being insertable through the mounting holes of the connection plate of the second mounting bracket, the first and second sets of fasteners being configured to couple to the rear wheel frame of the motorcycle, each of the first and second sets of fasteners including a nut-and-U-bolt assembly and a plurality of nut-and-bolt assemblies; and
a first wheel and a second wheel, the first wheel being rotatably coupled to the first mounting bracket, the second wheel being rotatably coupled to the second mounting bracket, the first and second wheels being configured to be translationally fixed with respect to a rear wheel of the motorcycle when the first and second mounting brackets are mounted to the rear wheel frame.

9. A motorcycle comprising:
a body having a rear wheel frame movably coupled to a main portion;
a rear wheel rotatably mounted to the rear wheel frame; and
a stabilizing apparatus comprising:
a first mounting bracket and a second mounting bracket, the first and second mounting brackets being mounted to a rear wheel frame of the motorcycle on opposite sides of the motorcycle from each other, each of the first and second mounting brackets comprising a rigid material; and
a first wheel and a second wheel, the first wheel being rotatably coupled to the first mounting bracket, the second wheel being rotatably coupled to the second mounting bracket, the first and second wheels being translationally fixed with respect to a rear wheel of the motorcycle.

10. The motorcycle of claim 9, wherein each of the first and second mounting brackets comprises:
a connection plate coupled to the rear wheel frame; and
an extension plate coupled to and extending away from the connection plate.

11. The motorcycle of claim 10, wherein the connection plate of each of the first and second mounting brackets further defines a plurality of mounting holes which extend through the connection plate, the motorcycle further comprising a first set of fasteners and a second set of fasteners, the first set of fasteners attaching the first mounting bracket to the rear wheel frame via being inserted through the mounting holes of the connection plate of the first mounting bracket, the second set of fasteners attaching the second mounting bracket to the rear wheel frame via being inserted through the mounting holes of the connection plate of the second mounting bracket, the first and second sets of fasteners being coupled to the rear wheel frame of the motorcycle.

12. The motorcycle of claim 11, wherein each of the first and second sets of fasteners includes a nut-and-U-bolt assembly and a plurality of nut-and-bolt assemblies.

13. The motorcycle of claim 10, wherein the connection plate and the extension plate of each of the first and second mounting brackets forms an L-shape.

14. The motorcycle of claim 10, wherein each of the first and second mounting brackets further comprises a pair of gussets coupled to the connection plate and the extension plate, the gussets being spaced from each other across the connection plate and the extension plate.
